(19) United States
(12) Patent Application Publication
(10) Pub. No.: US 2013/0094808 A1
(43) Pub. Date: Apr. 18, 2013

(54) METHOD AND SYSTEM FOR PRODUCING A COATED FIBER BRAGG GRATING OPTICAL FIBER

(71) Applicants: Daniel S. Homa, Blacksburg, VA (US); Christopher H. Lambert, Blacksburg, VA (US); Ajit Balagopal, Christiansburg, VA (US); Robert M. Harman, Troutville, VA (US)

(72) Inventors: Daniel S. Homa, Blacksburg, VA (US); Christopher H. Lambert, Blacksburg, VA (US); Ajit Balagopal, Christiansburg, VA (US); Robert M. Harman, Troutville, VA (US)

(73) Assignee: BAKER HUGHES INCORPORATED, Houston, TX (US)

(21) Appl. No.: 13/274,020

(22) Filed: Oct. 14, 2011

(51) Int. Cl. G02B 6/02; G02B 6/34

(52) U.S. Cl. 385/37; 427/163.2

(57) ABSTRACT

A method of producing a coated FBG optical fiber involves coating the optical fiber prior to writing the Bragg grating. A system for producing the coated FBG optical fibers includes a high temperature furnace from which to draw the fiber, a coating applicator that may be a carbon coating applicator, a cooling station, and a grating writing station.

### BACKGROUND OF THE INVENTION

1. Field of the Invention

The present invention relates to producing a fiber Bragg grating optical fiber with a coating.

2. Description of the Related Art

Optical fibers with fiber Bragg grating (FBG) are used as sensors due to their characteristic of reflecting certain wavelengths of light, which can be controlled based on the particular grating pattern, and transmitting all other wavelengths. FBG sensors can be particularly useful in situations that preclude physical access to a monitored system. For example, an FBG sensor may be used to sense inflation pressure of a packer used to isolate zones downhole.

A FBG is typically configured in a germanium-doped silica fiber. Such fibers tend to be susceptible to hydrogen diffusion, which can change the refractive index of the grating. This susceptibility can increase with fiber length. Prior art systems have described a coating applied to the fibers to hermetically seal the fiber. The prior view in the art is that the coating had to be applied after the grating process.

FIG. 1 illustrates the procedures involved in a process 100 of producing a coated FBG optical fiber according to the prior art. The process 100 begins with drawing the fiber (such as silica glass) from a high temperature furnace at block 5101. Block 5110 includes writing the Bragg grating onto the fiber to produce the FBG optical fiber. Block 5120 includes cooling the FBG optical fiber. At block S130, the process 100 concludes with reheating and coating the FBG optical fiber.

### BRIEF SUMMARY

According to one aspect of the invention, a method of producing a coated fiber Bragg grating (FBG) optical fiber includes drawing fiber from a high temperature furnace; coating the fiber; and writing a Bragg grating on the coated fiber to produce the coated FBG optical fiber.

According to another aspect of the invention, a coated fiber Bragg grating (FBG) optical fiber is produced by a process including drawing fiber from a high temperature furnace; coating the fiber; and writing a Bragg grating on the coated fiber to produce the coated FBG optical fiber.

According to yet another aspect of the invention, a system to produce a coated fiber Bragg grating (FBG) optical fiber includes a high temperature furnace from which an optical fiber is drawn; a coating applicator to coat the optical fiber; and a grating writing station to write a Bragg grating on the coated fiber and produce the coated FBG optical fiber.

According to yet another aspect of the invention, a hermetic carbon-coated fiber including fiber Bragg gratings (FBGs) includes a silica-based fiber; a carbon coating applied to the silica-based fiber; a Germanium dopant disposed in the coated silica-based fiber; a plurality of FBGs written in the doped silica-based fiber.

According to yet another aspect of the invention, a hermetic carbon-coated fiber including fiber Bragg gratings (FBGs) for downhole applications includes a silica-based fiber; a Germanium dopant disposed in the silica-based fiber; a plurality of FBGs written in the doped silica-based fiber, the FBGs being written at a higher density than for above-hole applications; and a carbon coating applied to the silica-based fiber with FBGs to hermetically seal the silica-based fiber with FBGs.

### BRIEF DESCRIPTION OF THE DRAWINGS

Referring now to the drawings wherein like elements are numbered alike in the several Figures:

FIG. 1 illustrates the steps involved in a process of producing a coated FBG optical fiber according to the prior art;

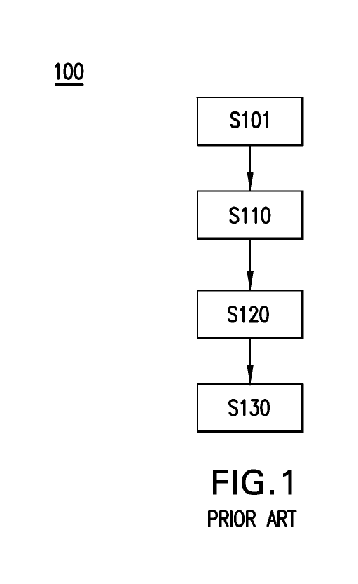

FIG. 2 illustrates the steps included in a process of producing a coated FBG optical fiber according to an embodiment of the invention; and

FIG. 3 is a block diagram of a system for producing a coated FBG optical fiber according to an embodiment of the invention.

### DETAILED DESCRIPTION

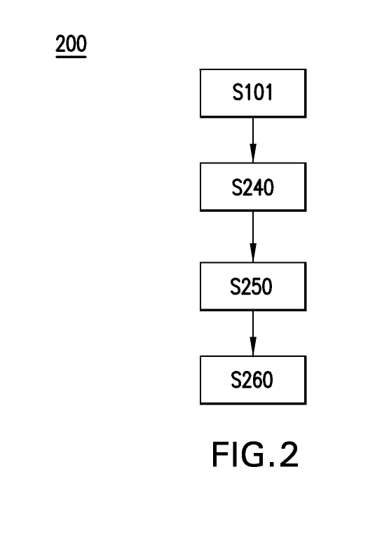

FIG. 2 illustrates the procedures included in a process 200 of producing a coated FBG optical fiber according to an embodiment of the invention. An optical fiber preform is heated and the process begins by drawing fiber from the high temperature furnace at block S101. However, unlike the prior art process 100, the process 200 next includes coating the fiber at block S240. After cooling the coated fiber at S250, the process concludes with writing the Bragg gratings on the coated fiber at block S260 to produce the coated FBG optical fiber.

The fiber drawn from the high temperature furnace at block S101 may be silica-based optical fiber, for example. The coating may be a carbon coating. The coating may also be a ceramic or metal material or diamond-like carbon (DLC) coating or any other suitable material capable of forming a hermetic barrier. The coating in some embodiments will reduce the diffusion of hydrogen or, alternatively, the coating in other embodiments will hermetically seal the fiber. The process of writing the Bragg gratings includes doping the optical fiber. For example, silica-based optical fiber may be doped with Germanium in order to write the FBG. For downhole applications, the density of the FBGs must typically be higher than for above-ground applications. The FBG optical fiber may be produced from the coated fiber at block S260 by exposing the fiber to a UV light that is passed through a phase mask.

The cooling and writing steps, S250 and S260, respectively, of the process 200 may be similar to but need not necessarily be the same as the cooling and writing steps, S120 and S110, respectively, of the prior art process 100 but they come at different places in the process. For example, at S120, the FBG optical fiber may be cooled to a certain temperature range in order to proceed to the reheating and coating step at S130. This temperature range may differ from the temperature range for the cooling of the coated fiber at S250. Also, the step of writing the Bragg grating on the fiber drawn from the furnace (at S101) to produce the FBG optical fiber at S110 may differ from the step of the writing the Bragg grating on the already-coated fiber at S260.

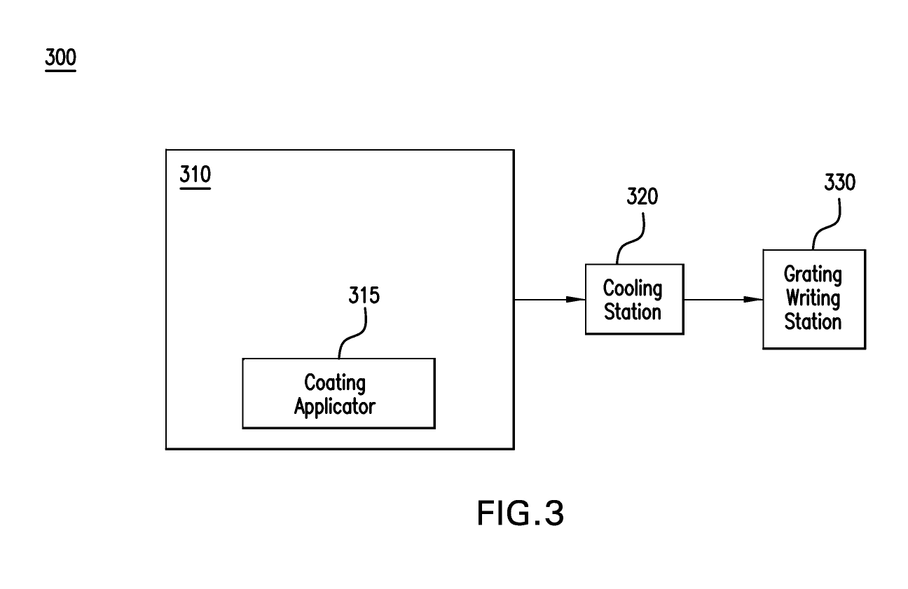

FIG. 3 is a block diagram of a system 300 for producing a coated FBG optical fiber according to an embodiment of the invention. The system 300 includes a high temperature furnace 310 with a coating applicator 315, a cooling station 320, and a grating writing station 330. The furnace 310 is, for example, a fiber draw furnace designed to operate to 2400° C. depending on the diameter of the preform. The coating applicator 315 may be on the floor of the draw furnace 310 itself, for example. The coating applicator 315 may instead be housed separately in such a way that the drawn fiber can have the coating applied by the coating applicator 315 before it cools down. The coating applicator 315 may be a carbon coating applicator and may pull the fiber through a carbon material. The coating applied by the coating applicator 315 may also be a ceramic or metal material or diamond-like carbon (DLC) coating or any other suitable material capable of forming a hermetic barrier. The cooling station 320 may be an area where the coated fiber is allowed to cool or may actively cool the coated fiber. The grating writing station 330 would include the ability to dope the optical fiber in order to write the grating. The grating writing station 330 may expose the fiber to a UV light that is passed through a phase mask.

Elements of the embodiments have been introduced with either the articles “a” or “an.” The articles are intended to mean that there are one or more of the elements. The terms “including” and “having” are intended to be inclusive such that there may be additional elements other than the elements listed. The conjunction “or” when used with a list of at least two terms is intended to mean any term or combination of terms. The terms “first” and “second” are used to distinguish elements and are not used to denote a particular order.

It will be recognized that the various components and technologies may provide certain necessary or beneficial functionality or features. Accordingly, these functions and features as may be needed in support of the appended claims and variations therefore, are recognized as being inherently included as a part of the teachings herein and a part of the invention disclosed.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

1. A method of producing a coated fiber Bragg grating (FBG) optical fiber, the method comprising:
drawing fiber from a high temperature furnace;
coating the fiber; and
writing a Bragg grating on the coated fiber to produce the coated FBG optical fiber.

2. The method according to claim 1, wherein the coating forms a hermitic seal on the fiber.

3. The method according to claim 1, further comprising:
cooling the coated fiber prior to the writing.

4. The method according to claim 1, wherein the coating includes pulling the fiber through a carbon material.

5. The method according to claim 1, wherein the coating includes applying a ceramic or metal material or diamond-like carbon (DLC) coating.

6. A coated fiber Bragg grating (FBG) optical fiber produced by a process comprising:
drawing fiber from a high temperature furnace;
coating the fiber; and
writing a Bragg grating on the coated fiber to produce the coated FBG optical fiber.

7. The coated FBG optical fiber according to claim 6, wherein the process further comprises cooling the coated fiber prior to the writing.

8. The coated FBG optical fiber according to claim 6, wherein the coated FBG optical fiber is coated with a carbon coating.

9. The coated FBG optical fiber according to claim 6, wherein the coated FBG optical fiber is coated with a ceramic or metal material or diamond-like carbon (DLC) coating or another material that forms a hermetic barrier.

10. A system to produce a coated fiber Bragg grating (FBG) optical fiber, the system comprising:
a high temperature furnace from which an optical fiber is drawn;
a coating applicator to coat the optical fiber; and
a grating writing station to write a Bragg grating on the coated fiber and produce the coated FBG optical fiber.

11. The system according to claim 10, further comprising:
a cooling station to cool the coated fiber.

12. The system according to claim 10, wherein the high temperature furnace heats a silica-based fiber so that the fiber is drawn out at a desired diameter.

13. The system according to claim 10, wherein the coating applicator applies a carbon coating to the optical fiber.

14. The system according to claim 10, wherein the coating applicator applies a ceramic or metal material or diamond-like carbon (DLC) coating to the optical fiber.

15. A hermetic carbon-coated fiber including fiber Bragg gratings (FBGs), the fiber comprising:
a silica-based fiber;
a carbon coating applied to the silica-based fiber;
a Germanium dopant disposed in the coated silica-based fiber;
a plurality of FBGs written in the doped silica-based fiber.

16. A hermetic carbon-coated fiber including fiber Bragg gratings (FBGs) for downhole applications, the fiber comprising:
a silica-based fiber;
a Germanium dopant disposed in the silica-based fiber;
a plurality of FBGs written in the doped silica-based fiber, the FBGs being written at a higher density than for above-hole applications; and
a carbon coating applied to the silica-based fiber with FBGs to hermetically seal the silica-based fiber with FBGs.
